(19) United States
(12) Patent Application Publication
(10) Pub. No.: US 2025/0360888 A1
(43) Pub. Date: Nov. 27, 2025

(54) IN-VEHICLE RADAR DEVICE MOUNTING STRUCTURE

(71) Applicant: TOYOTA JIDOSHA KABUSHIKI KAISHA, Toyota-shi (JP)

(72) Inventor: Eisuke IKENO, Toyota-shi (JP)

(73) Assignee: TOYOTA JIDOSHA KABUSHIKI KAISHA, Toyota-shi (JP)

(21) Appl. No.: 19/015,666

(22) Filed: Jan. 10, 2025

(30) Foreign Application Priority Data
May 24, 2024 (JP) 2024-085102

(51) Int. Cl. B60R 19/48; G01S 7/02; G01S 13/931

(52) U.S. Cl. CPC B60R 19/483; G01S 7/027; G01S 13/931; G01S 2013/93275

(57) ABSTRACT

An in-vehicle radar device mounting structure includes a bumper cover provided with a recessed portion having an inner side as a recess, a bracket portion disposed in the recessed portion and capable of attaching an in-vehicle radar device for transmitting and receiving radar waves to and from the bumper cover, and a cover portion having a ridgeline through which a central axis of the radar wave passes and that covers the recessed portion and the in-vehicle radar device.

### CROSS-REFERENCE TO RELATED APPLICATION

This application claims priority to Japanese Patent Application No. 2024-085102 filed on May 24, 2024, incorporated herein by reference in its entirety.

### BACKGROUND

### 1. Technical Field

The present disclosure relates to in-vehicle radar device mounting structures.

### 2. Description of Related Art

Japanese Unexamined Patent Application Publication No. 2005-37139 (JP 2005-37139 A) discloses a structure in which an in-vehicle radar device is mounted on a back surface of a bumper cover via a bracket.

### SUMMARY

In the structure described in JP 2005-37139 A, however, it is difficult to mount the in-vehicle radar device to a ridge portion such as a design corner of a vehicle, which may reduce design flexibility of a design surface. On the other hand, the closer the central axis of a radar wave that transmits through the bumper cover is to a design surface, the more the transmission properties of the radar wave are improved. Moreover, the more symmetrical the design surface is with respect to the central axis, the higher the output value of the radar wave that is transmitted and received. Therefore, there is room for improvement in the shape of the bumper cover.

The present disclosure was made in view of the above circumstances, and an object of the present disclosure is to provide an in-vehicle radar device mounting structure that improves radar wave output and that is less likely to reduce design flexibility of a design surface.

An in-vehicle radar device mounting structure of the present disclosure of claim 1 includes:
a bumper cover including a recessed portion that is recessed inward;
a bracket portion disposed in the recessed portion and configured to mount an in-vehicle radar device on the bumper cover, the in-vehicle radar device being configured to transmit and receive a radar wave; and
a cover portion covering the recessed portion and the in-vehicle radar device, the cover portion including a ridgeline through which a central axis of the radar wave passes.

In the in-vehicle radar device mounting structure of the present disclosure of claim 1, the in-vehicle radar device is mounted in the recessed portion of the bumper cover via the bracket portion, and the cover portion including the ridgeline through which the central axis of the radar wave that is transmitted and received by the in-vehicle radar device passes covers the recessed portion and the in-vehicle radar device. Therefore, providing the recessed portion in a ridgeline portion such as a corner of the bumper cover makes it possible to mount the in-vehicle radar device in a design corner of a vehicle. As a result, design flexibility of a design surface is less likely to be reduced. The cover portion covers the recessed portion and the in-vehicle radar device in such a manner that the central axis of the radar wave that is transmitted and received by the in-vehicle radar device passes through the ridgeline of the cover portion. This allows design surfaces on both sides of the ridgeline to be positioned on both sides of the central axis of the radar wave. With the cover portion including the ridgeline through which the central axis of the radar wave passes, the design surfaces can be formed more symmetrically with respect to the central axis of the radar wave compared to a cover portion with no ridgeline through which the central axis of the radar wave passes. This configuration improves the radar wave output.

According to the in-vehicle radar device mounting structure of the present disclosure of claim 2,
in the configuration of claim 1, the ridgeline may extend in a vehicle up-down direction.

In the in-vehicle radar device mounting structure of the present disclosure of claim 2, the ridgeline of the cover portion extends in the vehicle up-down direction. This allows to maintain design properties of the design corner of the vehicle.

According to the in-vehicle radar device mounting structure of the present disclosure of claim 3,
in the configuration of claim 1 or 2, the ridgeline may be a straight line with respect to which design surfaces located on both sides of the ridgeline are symmetrical.

In the in-vehicle radar device mounting structure of the present disclosure of claim 3,
the design surfaces located on both sides of the ridgeline through which the central axis of the radar wave passes are symmetrical with respect to the ridgeline. This configuration further improves the radar wave output.

According to the in-vehicle radar device mounting structure of the present disclosure of claim 4,
in the configuration according to any one of claims 1 to 3, the bumper cover may be a rear bumper cover that is attached to a rear side of a vehicle.

In the in-vehicle radar device mounting structure of the present disclosure of claim 4, the bumper cover is a rear bumper cover that is attached to the rear side of the vehicle. This configuration improves the radar wave output that is transmitted and received on the rear side of the vehicle, and is less likely to reduce design flexibility of a design surface in a rear part of the vehicle.

As described above, the in-vehicle radar device mounting structure of the present disclosure is advantageous in that it improves the radar wave output and is less likely to reduce design flexibility of a design surface.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a main part of a lower right rear portion of a vehicle to which a sensor mounting structure according to an embodiment of the present disclosure is applied;

FIG. 2 is a schematic perspective view of the main part of the lower right rear portion of the vehicle of FIG. 1 as viewed from the rear side of the vehicle with the cover portion removed;

FIG. 3 is a schematic perspective view of the main part of the lower right rear portion of the vehicle of FIG. 1, as viewed from the rear side of the vehicle, with the cover portion attached;

FIG. 4 is a schematic sectional view taken along line IV-IV in FIG. 3;

FIG. 5 is a schematic sectional view for explaining the radio wave transmittance of the surroundings information detection sensor; and

FIG. 6 is a graph showing the relationship between the direction from the center of the radar wave and the signal strength.

### DETAILED DESCRIPTION OF EMBODIMENTS

Hereinafter, a sensor mounting structure 10 as an in-vehicle radar device mounting structure according to an embodiment of the present disclosure will be described with reference to the drawings. Note that an arrow RR appropriately shown in the drawings indicates a rear side in the vehicle front-rear direction, and an arrow UP indicates an upper side in the vehicle up-down direction. The arrow RH indicates the right side (outer side) of the vehicle. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified.

First, the sensor mounting structure 10 according to an embodiment of the present disclosure is attached to left and right design corners on the rear side of the vehicle 12 as an example. The vehicle 12 is, for example, a vehicle that is driven by power generated by a power unit, such as a battery electric vehicle (BEV), a fuel cell electric vehicle (FCEV), a hybrid electric vehicle (HEV), or a plug-in hybrid electric vehicle (PHEV).

In the present embodiment, the sensor mounting structure 10 applied to the lower rear portion on the right side of the vehicle 12 will be described below. The sensor mounting structure applied to the lower rear portion on the left side of the vehicle 12 is symmetrical with respect to the configuration of the present embodiment. Therefore, the present disclosure can be applied to the rear lower portion on the left side of the vehicle 12 by setting the left side in the vehicle width direction to be the vehicle width direction outer side and the vehicle right side to be the vehicle width direction center side.

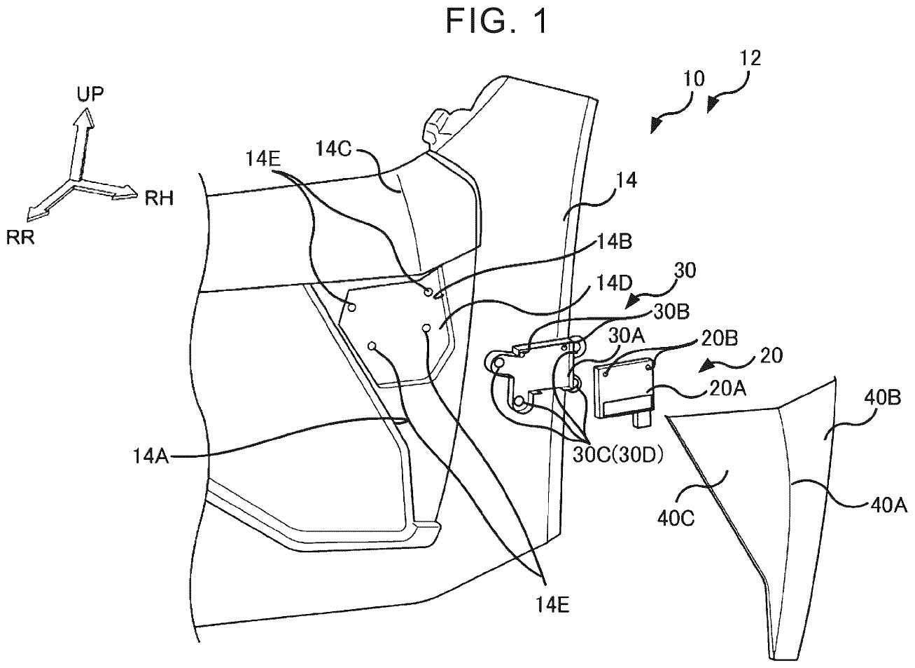

FIG. 1 is an exploded perspective view of a main part of a lower right rear portion of a vehicle 12 to which a sensor mounting structure 10 according to an embodiment of the present disclosure is applied. FIG. 1 schematically illustrates a main part of a lower right rear portion of the vehicle 12. As shown in FIG. 1, the sensor mounting structure 10 according to the present embodiment is applied to a rear portion of a vehicle 12. Specifically, the present disclosure is applied to the corners of the rear portion of the vehicle 12 on both sides in the vehicle width direction. The sensor mounting structure 10 includes a rear bumper cover 14, a bracket portion 30 capable of attaching the surroundings information detection sensor 20 to the rear bumper cover 14, and a cover portion 40.

The rear bumper cover 14 is disposed at the rear end of the vehicle 12, and extends in the vehicle width direction below a back door (not shown) that opens and closes a luggage compartment (not shown) as an example. The rear bumper cover 14 is attached to a body constituting a skeleton of the vehicle 12 via a bracket (not shown) or the like. In the present embodiment, the rear bumper cover 14 has a first recessed portion 14A having a substantially triangular shape with a lower portion as an apex at design corners on both sides in the vehicle widthwise direction, and a second recessed portion 14B as a substantially pentagonal recessed portion further provided in the first recessed portion 14A.

The first recessed portion 14A and the second recessed portion 14B are provided in the rear bumper cover 14 such that the vehicle width direction inner side (left side) is recessed. The first recessed portion 14A and the second recessed portion 14B are formed on an extension line of the bumper ridgeline 14C that is switched from the vehicle rear surface side to the vehicle right side surface at the design corner portion of the rear bumper cover 14. The bottom 14D of the second recessed portion 14B, four mounting holes 14E is provided as an example.

The bracket portion 30 includes a bracket main body 30A to which the surroundings information detection sensor 20 is attached, and four extension portions 30D extending outward from the bracket main body 30A and each having a hole 30C corresponding to the four mounting holes 14E of the second recessed portion 14B. The bracket main body 30A includes two sensor attachment holes 30B for attaching the surroundings information detection sensor 20 to an upper portion of the second recessed portion 14B in the vehicle up-down direction.

The surroundings information detection sensor 20 is a sensor that detects surroundings information of the vehicle 12, and the surroundings information detection sensor 20 disposed at the corner of the rear end of the vehicle 12 detects an object such as a pedestrian, another vehicle, or a structure existing behind the vehicle. The surroundings information detection sensor 20 detects a vehicle behind the vehicle by, for example, a millimeter wave radar. Specifically, the surroundings information detection sensor 20 is configured to radiate a radio wave in the millimeter wave band, receive the radio wave reflected by the object existing in the radiation range, and calculate the position of the object based on the time from the radiation of the radio wave to the reception. That is, the surroundings information detection sensor 20 of the present embodiment is a laser radar (LIDAR: Light Detection and Ranging) that irradiates an electromagnetic wave functioning as a radar wave. In the present embodiment, a blind spot monitor (BSM) is used as the surroundings information detection sensor 20.

surroundings information detection sensor 20, the upper portion in the vehicle up-down direction when attached to the recessed portion 14A, two holes 20B corresponding respectively to the two sensor mounting holes 30B provided in the bracket portion 30 is provided.

The cover portion 40 has a cover ridgeline 40A as a ridgeline extending along the vehicle up-down direction when attached to the rear bumper cover 14. The cover portion 40 has substantially the same shape as the first recessed portion 14A of the rear bumper cover 14 described above, and is formed of a substantially triangular plate member having an apex at the lower side. The cover ridgeline 40A is a straight line with respect to which the right design surface 40B and the rear design surface 40C located on both sides of the cover ridgeline 40A are substantial.

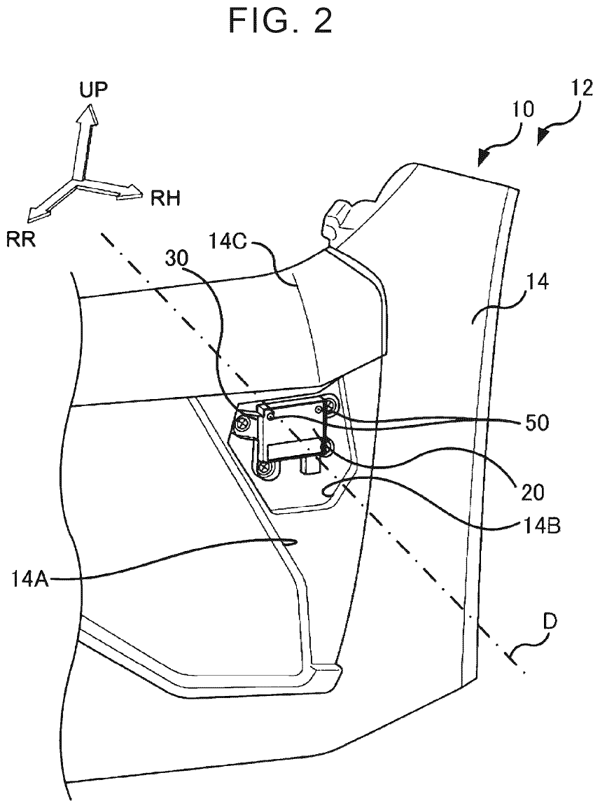

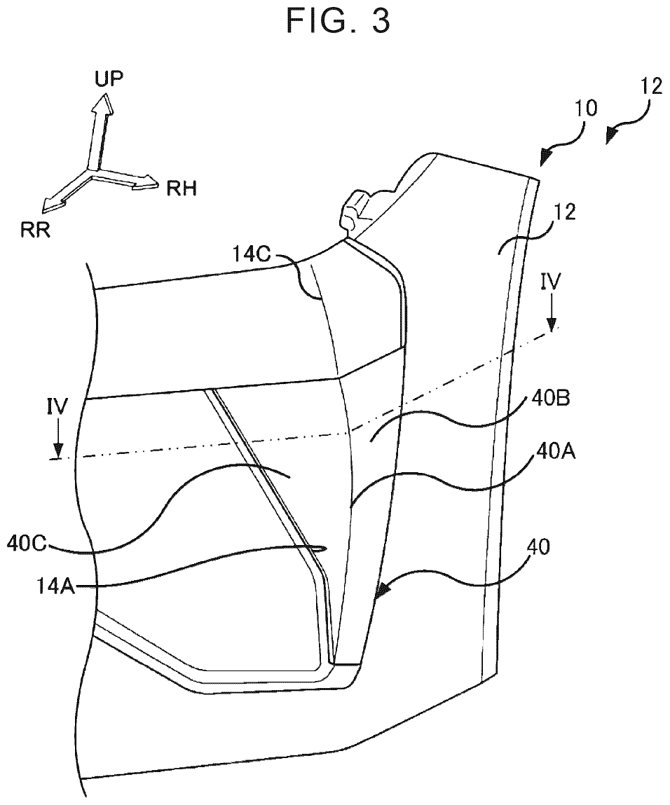

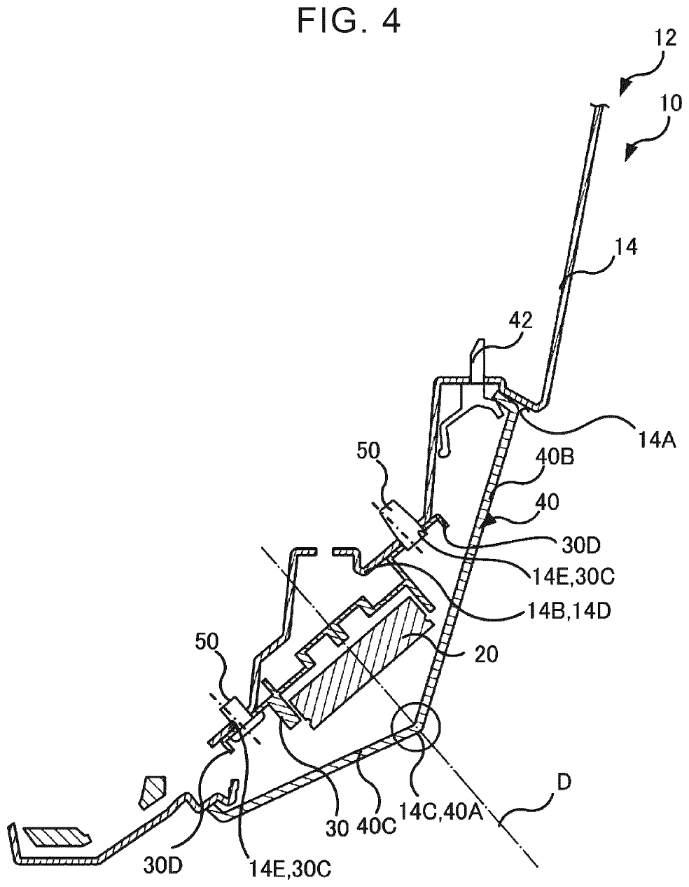

FIG. 2 is a schematic perspective view of the main part of the rear right lower portion of the vehicle 12 of FIG. 1 viewed from the vehicle rear side in a state where the cover portion 40 is removed, and FIG. 3 is a schematic perspective view of the main part of the rear right lower portion of the vehicle 12 of FIG. 1 viewed from the vehicle rear side in a state where the cover portion 40 is attached. FIG. 4 is a sectional view schematically illustrating a state of being cut along line IV-IV in FIG. 3.

As shown in FIG. 2, the bracket portion 30 to which the surroundings information detection sensors 20 are attached are attached to the second recessed portion 14B of the rear bumper cover 14. Two holes 20B provided in the surroundings information detection sensor 20 (see FIG. 1), in a state of overlapping the two sensor mounting holes 30B provided in the bracket portion 30 (see FIG. 1), screwing the screw member 50 as an example. Thus, the surroundings information detection sensor 20 is attached to the bracket portion 30.

As shown in FIGS. 2 and 4, the hole 30C provided in the extension portion 30D, while overlapping the mounting holes 14E provided on the bottom 14D of the second recessed portion 14B, screwing the screw member 50 as an example. Thus, the bracket portion 30 is attached to the rear bumper cover 14. In the present embodiment, as shown in FIG. 2, the bracket portion 30 is attached to the rear bumper cover 14 such that the central axis D of the radar wave radiated from the surroundings information detection sensor 20 passes through the bumper ridgeline C of the rear bumper cover 14 when viewed from the vehicle upper side.

Then, as shown in FIG. 3, the cover portion 40 is attached to the first recessed portion 14A of the rear bumper cover 14 with the surroundings information detection sensor 20 disposed. Specifically, the cover portion 40 is attached such that the cover ridgeline 40A and the bumper ridgeline 14C are positioned substantially on the same line. That is, as shown in FIG. 4, the bumper ridgeline 14C and the cover ridgeline 40A are aligned and the central axis D of the radar wave passes through the bumper ridgeline 14C and the cover ridgeline 40A as viewed from the vehicle upper side. Note that the cover portion 40 is fastened by a screw member, a bolt, or the like via the bracket 42 or the like as an example.

### Operations and Effects

Next, operations and effects of the present embodiment will be described.

In the sensor mounting structure 10 of the present embodiment, the surroundings information detection sensor 20 is attached to the second recessed portion 14B provided in the rear bumper cover 14 via the bracket portion 30. The cover portion 40 having the cover ridgeline 40A through which the central axis D of the radar wave that is transmitted and received by the surroundings information detection sensor 20 passes covers the second recessed portion 14B and the surroundings information detection sensor 20. Therefore, by providing the second recessed portion 14B in the bumper ridgeline 14C part such as the corner part of the rear bumper cover 14, the surroundings information detection sensor 20 can be attached to the design corner part of the vehicle 12, so that the degree of freedom of the design surface can be prevented from being suppressed. In addition, the cover portion 40 covers the second recessed portion 14B and the surroundings information detection sensor 20 such that the central axis D of the radar wave transmitted and received by the surroundings information detection sensor 20 passes through the cover ridgeline 40A of the cover portion 40. Therefore, the design surfaces 40B, 40C located on both sides of the cover ridgeline 40A can be positioned on both sides of the central axis D of the radar wave.

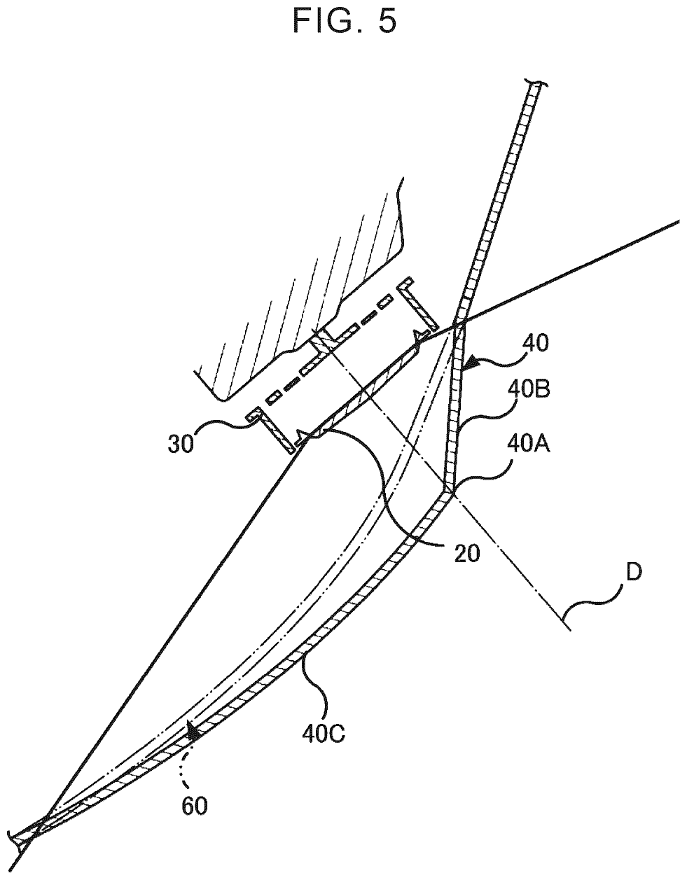

FIG. 5 is a schematic sectional view for explaining the radio wave transmittance of the surroundings information detection sensor 20. As shown in FIG. 5, with respect to the cover portion 40 of the present embodiment having the design surfaces 40B, 40C symmetrical to the central axis D of the radar wave, the cover portion 60 shown by a long dashed double-short dashed line has a design surface that is asymmetrical with respect to the central axis D of the radar wave. In other words, the cover portion 60 does not have the cover ridgeline 40A through which the central axis D of the radar wave passes.

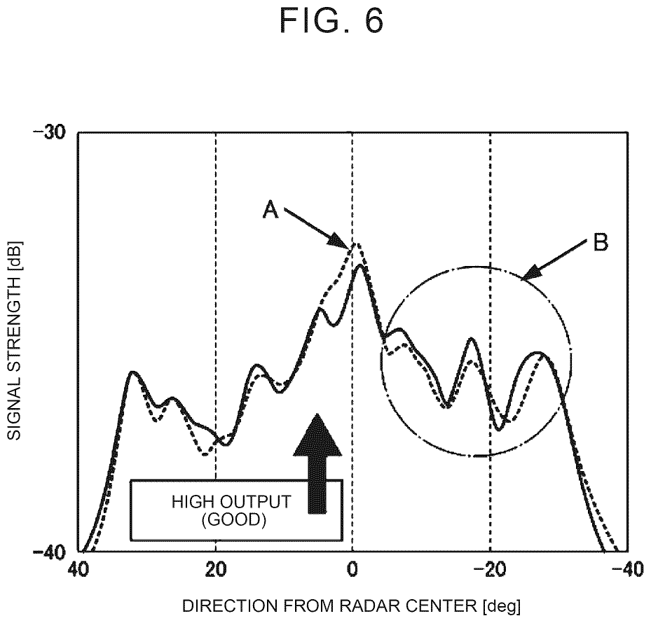

There are cases where the cover portion 40 of the present embodiment is attached to the first recessed portion 14A of the rear bumper cover 14, and cases where the cover portion 60 shown in FIG. 5 is attached. In these cases, the signal strength (dB) of the reception when the radar wave is received by radiating the radar wave in the direction (angle; deg) from the central axis D of the radar wave was measured. That is, the output value of the radar wave transmitted through the cover portion 40 or the cover portion 60 was measured. FIG. 6 is a graph showing a relationship between a direction from a center (central axis D) of a radar wave and a signal strength. In FIG. 6, a solid line indicates a case where the cover portion 40 is attached, and a dotted line indicates a case where the cover portion 60 is attached.

As shown in FIG. 5, when the distance from the central axis D is short, the cover portion 60 is closer to the surroundings information detection sensor 20 than the cover portion 40. Therefore, as indicated by arrow A in FIG. 6, the cover portion 60 having an asymmetric design surface on the central axis D of the radar wave has a higher signal strength than the cover portion 40 of the present embodiment having the design surfaces 40B, 40C symmetrical to the central axis D of the radar wave. However, the distance from the central axis D of the radar wave may be increased as in a circle indicated by a long dashed short dashed line indicated by arrow B. In this embodiment, the cover portion 40 having the design surfaces 40B, 40C symmetrical to the central axis D of the radar wave is higher in signal strength than the cover portion 60 having the design surface that is asymmetrical with respect to the central axis D of the radar wave. That is, the higher the symmetry between the design surfaces of the cover portions 40, 60 and the central axis D of the radar wave, the higher the radio wave transmittance.

The cover portion 40 of the present embodiment covers the second recessed portion 14B and the surroundings information detection sensor 20 such that the central axis D of the radar wave transmitted and received by the surroundings information detection sensor 20 passes through the cover ridgeline 40A of the cover portion 40. Therefore, the design surfaces 40B, 40C positioned on both sides of the cover ridgeline 40A can be positioned on both sides of the central axis D of the radar wave. Thus, the cover portion 40 having the cover ridgeline 40A through which the central axis D of the radar wave passes, compared to the cover portion that does not have the cover ridgeline 40A through which the central axis D of the radar wave passes, it is possible to form the design surface more symmetrically with respect to the central axis D of the radar wave. Therefore, the output of the radar wave can be improved.

Further, in the sensor mounting structure 10 of the present embodiment, the design surfaces 40B, 40C located on both sides of the cover ridgeline 40A through which the central axis D of the radar wave passes is symmetrical with the cover ridgeline 40A, so that the radar wave output can be further improved.

Further, in the sensor mounting structure 10 of the present embodiment, since the cover ridgeline 40A of the cover portion 40 extends in the vehicle up-down direction, the design property of the design corner portion of the vehicle 12 can be maintained.

Further, in the sensor mounting structure 10 of the present embodiment, the bumper cover to which the surroundings information detection sensor 20 is attached is the rear bumper cover 14 which is attached to the vehicle rear side. Therefore, it is possible to improve the output of the radar waves transmitted and received on the rear side of the vehicle, and to prevent the suppression of the degree of freedom of the design surface of the rear portion of the vehicle 12.

### SUPPLEMENTARY EXPLANATION

In the above embodiment, the second recessed portion 14B and the cover portion 40 have a substantially triangular shape, but the present disclosure is not limited thereto. Any shape can be used as long as the shape can form the cover ridgeline 40A.

In addition, in the above embodiment, the sensor mounting structure 10 as the in-vehicle radar device mounting structure is mounted on the design corner portion of the rear bumper cover 14, but the present disclosure is not limited thereto, and may be mounted on the design corner portion of the front bumper cover.

In the sensor mounting structure 10 of the above embodiment, the rear bumper cover 14 includes the first recessed portion 14A and the second recessed portion 14B, but the present disclosure is not limited thereto. For example, only the first recessed portion 14A may be provided. Here, the mounting holes 14E are provided at the bottom of the first recessed portion 14A.

In addition, the sensor mounting structure 10 of the above embodiment can be adopted in a plurality of vehicle types by making only the cover portion 40 and the bumper cover 14 for each vehicle type new.

The configuration of the present disclosure is not limited to the above embodiment, and the configuration can be changed as appropriate as long as the problem can be solved.

What is claimed is:

1. An in-vehicle radar device mounting structure comprising:
a bumper cover including a recessed portion that is recessed inward;
a bracket portion disposed in the recessed portion and configured to mount an in-vehicle radar device on the bumper cover, the in-vehicle radar device being configured to transmit and receive a radar wave; and
a cover portion covering the recessed portion and the in-vehicle radar device, the cover portion including a ridgeline through which a central axis of the radar wave passes.

2. The in-vehicle radar device mounting structure according to claim 1, wherein the ridgeline extends in a vehicle up-down direction.

3. The in-vehicle radar device mounting structure according to claim 1, wherein the ridgeline is a straight line with respect to which design surfaces located on both sides of the ridgeline are symmetrical.

4. The in-vehicle radar device mounting structure according to claim 1, wherein the bumper cover is a rear bumper cover that is attached to a rear side of a vehicle.
